(19) United States
(12) Patent Application Publication
(10) Pub. No.: US 2007/0084162 A1
(43) Pub. Date: Apr. 19, 2007

(54) Apparatus for cleaning air

(75) Inventors: Dieter Seipler, Leonberg (DE); Marcel Hofmeister, Ludwigsburg (DE); Nikolaus Moser, Ditzingen (DE); Horst Keller, Kirchheim (DE); Ulrich Stolz, Kirchheim (DE)

Correspondence Address: CROWELL & MORING LLP;INTELLECTUAL PROPERTY GROUP, P.O. BOX 14300, WASHINGTON, DC, 20044-4300, US

(73) Assignees: Mann & Hummel GmbH, Ludwigsburg (DE); Keller Lufttechnik GmbH & Co. KG, Kirchheim (DE)

(21) Appl. No.: 11/519,941

(22) Filed: Sep. 13, 2006

(30) Foreign Application Priority Data
Sep. 13, 2005 (DE) 10 2005 043 791.5

(51) Int. Cl. B01D 46/00

(52) U.S. Cl. 55/380

(57) ABSTRACT

An apparatus for purification of air comprising comprises a housing having inlet openings for supplying the air to be cleaned and outlet openings for discharging the cleaned air, a filter system disposed in the housing, and a fan arranged to draw air through the housing and filter system. The filter system includes at least one tubular or bag-shaped fleece filter which is arranged on top of a carrier structure and at least one secondary filter element which has a filter fineness which is smaller than the filter fineness of the fleece filter. The entire apparatus is arranged either stationarily or moveably in regions of greater to lesser dust concentration. The cleaned air is conveyed to the region with the higher local dust concentration and thereby significantly decreases the local dust concentration.

### BACKGROUND OF THE INVENTION

The invention relates to an apparatus for cleaning air, particularly from dust and fine dust, which is arranged in a housing and comprises at least one filter system.

Published German patent application no. DE 22 55 868 discloses a room air purifying apparatus in which the unpurified air is drawn by a fan through an air inlet opening into a container and passes through a series of filters. The filter arrangement comprises a dust filter, an electrostatic dust collector, a grounded metallic filter element, a chemically active filter and an active carbon filter. A disadvantage of this apparatus is that a plurality of different filter systems are required which must be regularly exchanged or serviced or cleaned. This represents a high additional cost and causes significant expense.

Further, an aerosol separator is known from published German patent application no. DE 100 64 911 in which an aerosol-containing raw gas is passed through a plurality of demisters and the aerosol is caused to coalesce and then precipitate. Dust separation is not envisioned in this system.

Published European patent application no. EP 1 445 011 discloses an air purifying fan, which also serves to remove dust contaminant particles or similar contaminants from room air and humidifies the transiting air stream by means of liquid medium. The contaminants are collected in a reservoir for the liquid medium and can be discharged. This air purifying fan is used particularly where a strong dust or contaminant accumulation arises, for example, during building construction in enclosed spaces. A disadvantage of this system is that only relatively coarse particles can be discharged by this system and a high air throughput, as well as a high degree of filtration, is not possible since a transfer of the particles from the air into the liquid must take place.

### SUMMARY OF THE INVENTION

It is an object of the invention to provide an air purifying apparatus which avoids avoiding the aforementioned disadvantages.

A further object of the invention is to provide an air purifying apparatus for purifying large amounts of air which achieves a high filtration performance and, at the same time, a high degree of filtration.

These and other objects are achieved in accordance with the present invention by providing an apparatus for purification of air, comprising a housing, a fan arranged in the housing, and a filter system, wherein the housing has inlet openings for supplying air to be cleaned and outlet openings for discharging the cleaned air, and wherein the filter system is comprised of at least one tubular or bag-shaped fleece filter arranged on top of a carrier structure and at least one secondary filter element, which has a filter fineness which is smaller than the filter fineness of the fleece filter.

A substantial advantage of the invention is that the apparatus comprises a filter system in which an array of fleece filters is provided which is arranged in the form of a tube or bag and is disposed on a carrier structure. With the fleece filter, it is possible to achieve a very high degree of filtration at a low differential pressure across the element. Due to the depth effect, the fleece filter is able to capture even fine dust and reliably filter it out of the supplied air. The entire apparatus is stationarily disposed in an area of high dust concentrations.

In one embodiment of the invention, the carrier structure for the fleece filter element is a secondary filter element, preferably of membrane material. On the one hand, this achieves the purpose of increasing the stability of the fleece filter and, on the other hand, it further increases the reliability of the filter or the degree of filtration. In particular, the secondary filter elements have the purpose of preventing any dirt or dust, which possibly may fall from the primary filter element when the primary filter element is being exchanged, from penetrating into the clean air zone.

Preferably, the secondary filter element is constructed of polytetrafluoroethylene (PTFE) and in the form of a membrane. Such a membrane is, for example, laminated onto a rigid body medium. The rigid body medium can be a porous synthetic resin body, such as, for example, sintered polyethylene, on which a PTFE-membrane is laminated.

In accordance with a further embodiment of the invention, the apparatus is comprised of one or more filter cartridge arrays, in which each array is mounted in a common frame. In this way, a large filter surface can be achieved, and it is possible to exchange the filter cartridges with the respective frame, which is arranged in a corresponding shaft.

In one advantageous embodiment, the frame serves to attach and seal the fleece filter. This means that in the region of attachment of the frame, the fleece filter is clamped against a mounting and thus on the one hand effects a seal between the mounting and frame and, on the other hand, simultaneously also effects the fixation of the fleece filter. According to a further embodiment of the invention, a plurality of frames are arranged parallel and immediately adjacent one another, whereby each frame simultaneously effects the fixation of the fleece filter.

Advantageously, each of the filter cartridge arrays is provided with its own tube or bag-formed fleece filter element. This has the advantage that it is possible to exchange the fleece filter in a simple manner by disassembling a series of filter cartridges.

In accordance with a further embodiment, the fleece filter or the secondary filter element can be provided with a catalytically active layer. This can be a manganese dioxide, copper oxide or iron oxide, which is appropriately activated so that, for example, CO is transformed into CO₂ by this catalytic effect.

In accordance with a further embodiment of the invention, at least one pressure sensor is provided for determining the pressure difference between the unfiltered air side and the clean air side, whereby the signals of the pressure sensor are directly displayed on the apparatus or also can be transmitted via a remote maintenance system to a central maintenance location.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawing figure, in which:

FIG. 1 is a vertical sectional view of an individual rigid body filter with a tubular fleece filter therearound;

FIG. 2 is a vertical sectional view of a series of filter cartridges;

FIG. 2a is a top view of the series of filter cartridges of FIG. 2 taken along section line A-A of FIG. 2, and

FIG. 3 is a schematic sectional view of a complete air purifying apparatus according to the invention.

### DETAILED DESCRIPTION OF PREFERRED EMBODIMENTS

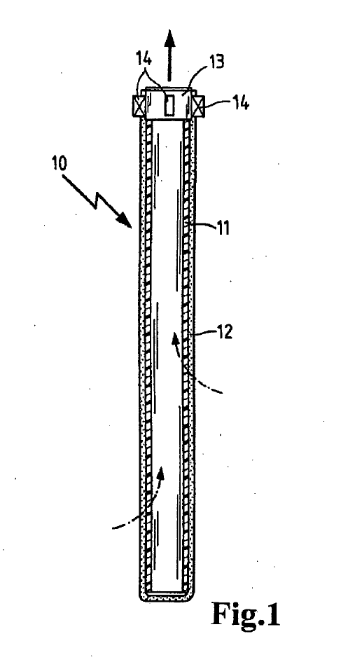

In FIG. 1, a filter element 10 is depicted. This is comprised of a rigid body filter 11 and a tube-form fleece filter 12. The rigid body filter 11 comprises, in the upper region, a receptacle 13. This can be, for example, a sleeve, in which the rigid body filter 11 is fastened. On this receptacle 13, the fleece filter 12 is fixed against a fastening point. The rigid body filter 11 itself is comprised of a carrier material, for example, a sintered synthetic resin material, on which a PTFE-membrane is disposed. The fleece filter 12 can lie directly on the PTFE-membrane. But it is also possible to provide a space between the membrane and the fleece filter. The rigid body filter is constructed concentrically in the form of a tube, the air flows from the outside through the fleece filter and subsequently inwardly through the membrane and through the support body. In the inner area of the rigid body filter, it is conducted away in cleaned condition upwardly in the direction of the arrow.

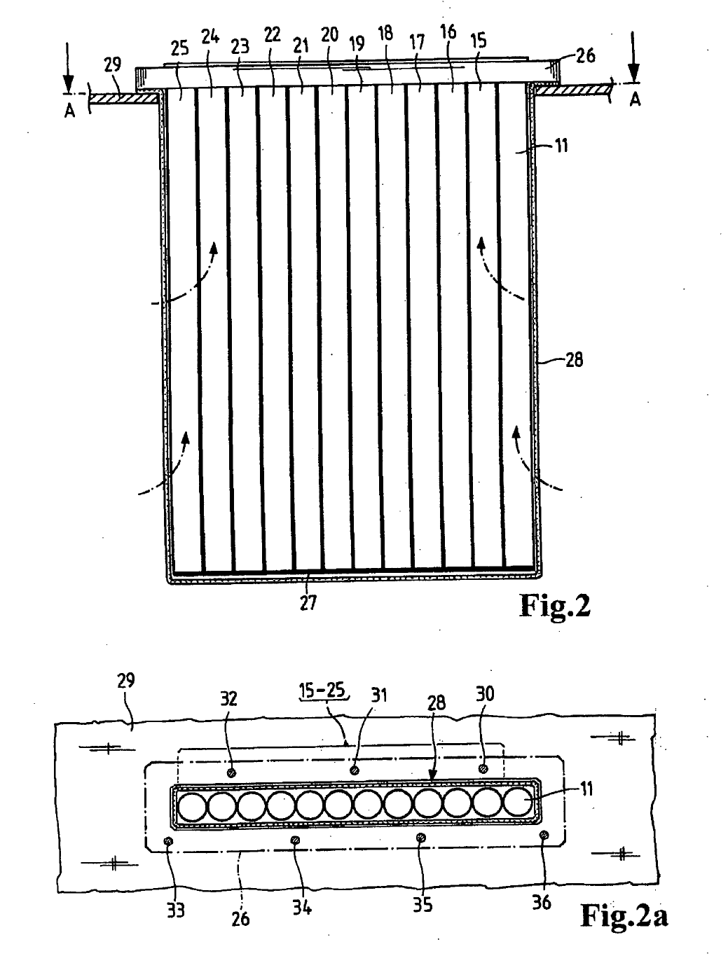

FIG. 2 shows a series of filter cartridges in a filter array, whereby the individual rigid body filters 11 and 15-25 are identically constructed and correspond in their structure to the filter described in FIG. 1. These are mounted in a common receptacle 26. This receptacle is, for example, a synthetic resin lock, which has corresponding openings in which the rigid body filters are glued or welded. The filter elements 11, 15-25 can be connected with each other in the lower region via a common fastening rail 27. Due to the suspended construction, it is, however, sufficient merely to fix them in the receptacle 26. The fleece filter 28 surrounds all of the tubes and is constructed in the form of a single large bag which extends into the receptacle 26. There the attachment of both the entire block, as well as the fleece filter 28, to a carrier is effected. The upper region of the fleece filter 28 is clamped between the carrier 29, which is attached, for example, to a metal frame, and the receptacle 26, and thereby also simultaneously sealed. The air to be cleaned also flows in this case from the outside through the fleece filter 28 and then through the individual rigid filter bodies and is subsequently carried away upwardly in the area of the receptacle.

FIG. 2a shows a top plan view of the row of filter cartridges which is fastened in the receptacle 26. Similar parts are identified by the same reference numerals. The receptacle 26 is attached to the carrier 29, for example, via screws 30, 31, 32, 33, 34, 35, 36. The fleece filter 28 is clamped and sealed there around.

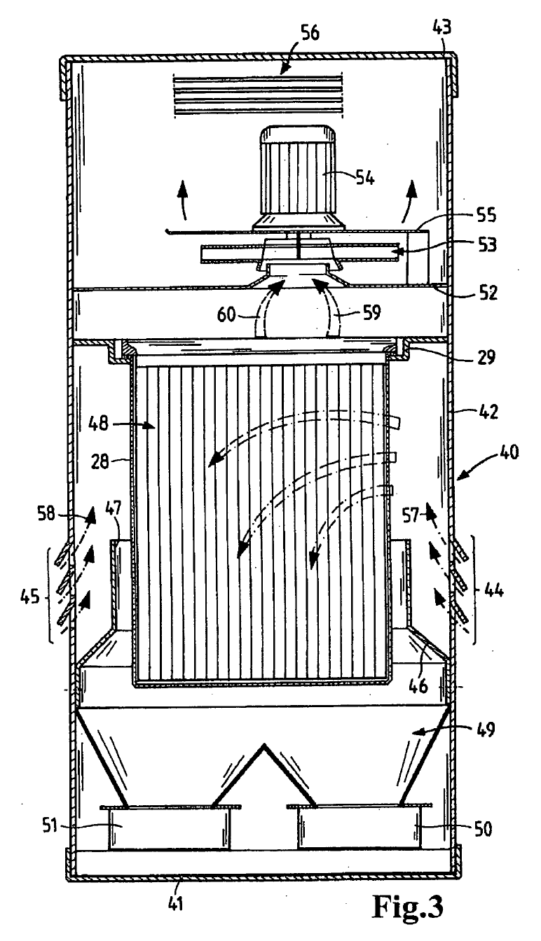

FIG. 3 shows a complete apparatus for purification of air, which can be set up in a stationary manner in interior or exterior spaces which are especially strongly contaminated with dust or fine dust. The housing 40 is comprised of a floor 41, walls 42, as well as a cover 43. The housing has inlet slots 44, 45, as well as guide blades 46, 47 arranged behind the inlet slots. The filter apparatus 48, as described in FIG. 2, is located centrally inside the housing 40. Within the housing 40, a plurality of these filter apparatus can be arranged one behind the other.

In the figure, only one filter apparatus is illustrated. Of course, it is possible to arrange a plurality of filter apparatuses immediately adjacent one another so that in a single housing, which has a rectangular base, ten to fifteen of these filter devices can be installed. The filter apparatuses are mounted on a common carrier 29. Underneath the filter apparatuses, there is dirt collection chamber 49. The contaminants which fall off the filter apparatuses can fall from there into two collecting containers 50, 51 and be disposed of. Above the carrier 29, there is initially an air guide vane 52 and, above the air guide vane 52, a fan 53, which is driven an electric motor 54. The electric motor 54 is attached to a support flange 55 above the fan 53. At the same time, outlet slots 56 in the housing are provided in the area of the electric motor 54. In the figure, the outlet slots of the rear room are illustrated. Of course, outlet slots also can be provided on the front wall or on the two side walls. Insofar—as shown, the inlet slots are located on the side walls, it is advantageous to arrange the outlet slots on the front and rear walls. In this way, an optimal cleansing of the surrounding air is achieved since a continuous circulation of the purified air is created.

The housing 40 has noise insulation in the vicinity of the electric motor and the outlet slots so that little or no operating noise reaches the exterior. The air to be cleaned flows in accordance with the arrows 57, 58 into the housing 40, is distributed among the individual filter apparatus 48, where it next flows through the respective fleece filter 28 and subsequently through the rigid body filter and leaves the tubes in accordance with the arrows 59, 60. The cleaned air is transported upwardly by the fan and flows away through the outlet slots 56. Because of the structure of the filters, it was possible to achieve an air throughput of up to 10 m³/min. In order to clean the filter elements or fleece filters, the individual filter apparatuses 48 are released from the carrier 29 and removed through the top. The fleece filter 28 is likewise taken off in an upward direction and replaced by a new fleece filter. Since the fleece filter achieves a degree of separation of 99.99%, it is not necessary to clean the rigid body filters 11 themselves.

It is also possible to install the filter apparatuses 48 in the housing from the side so that the individual filter elements extend horizontally. This type of installation makes possible a simple exchange of the individual fleece filters without removing the air propulsion system, which is located in the upper region of the housing.

The entire apparatus is positioned either stationarily or moveably in regions of greater or lesser dust concentrations. The cleaned air is directed to the region with the higher local dust concentration and thereby significantly reduces the local concentration.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. An apparatus for purification of air, comprising a housing, a fan arranged in the housing, and a filter system, wherein the housing has inlet openings for supplying air to be cleaned and outlet openings for discharging the cleaned air, and wherein the filter system is comprised of at least one tubular or bag-shaped fleece filter arranged on top of a carrier structure and at least one secondary filter element, which has a filter fineness which is smaller than the filter fineness of the fleece filter.

2. An apparatus according to claim 1, wherein said apparatus is fixedly mounted in a contaminated air region to draw in contaminated air from said contaminated air region and discharge cleaned air to said contaminated air region thereby reducing the level of contamination of the air.

3. An apparatus according to claim 1, wherein said apparatus is movably mounted so as to be transportable to a contaminated air region to draw in contaminated air from said contaminated air region and discharge cleaned air to said contaminated air region thereby reducing the level of contamination of the air.

4. An apparatus according to claim 1, wherein the carrier structure for the fleece filter is formed by the secondary filter element.

5. An apparatus according to claim 1, wherein the secondary filter element comprises a filter membrane composed of polytetrafluoroethylene.

6. An apparatus according to claim 1, wherein the secondary filter element comprises a series of individual filter cartridges mounted in a common frame.

7. An apparatus according to claim 6, wherein the frame comprises means for fastening and sealing the fleece filter.

8. An apparatus according to claim 7, wherein a plurality of frames, each comprising means for mounting and sealing a fleece filter, is arranged parallel to each other in the apparatus.

9. An apparatus according to claim 1, wherein the fleece filter or the secondary filter element is provided with a catalytically active layer.

10. An apparatus according to claim 1, wherein the secondary filter comprises a plurality of filter cartridges mounted in a common frame, and the primary filter comprises a single tubular or bag-shaped fleece filter surrounding the secondary filter.

11. An apparatus according to claim 1, further comprising a pressure sensor for determining the pressure difference across the filter apparatus; said pressure sensor generating a signal to exchange the fleece filter element when the determined pressure difference exceeds a maximum desired value.

12. An apparatus according to claim 1, further comprising a remote servicing device for transmitting filter performance characterizing data of the filter apparatus to a central service monitoring location.
